(19) United States
(12) Patent Application Publication
(10) Pub. No.: US 2017/0308296 A1
(43) Pub. Date: Oct. 26, 2017

(54) STAGING WRITE REQUESTS

(71) Applicant: Hewlett Packard Enterprise Development LP, Houston, TX (US)

(72) Inventors: Gregg B. Lesartre, Fort Collins, CO (US); Martin Foltin, Fort Collins, CO (US)

(21) Appl. No.: 15/136,827

(22) Filed: Apr. 22, 2016

(51) Int. Cl. G06F 3/06

(52) U.S. Cl. CPC G06F 3/061; G06F 3/0659; G06F 3/0685

(57) ABSTRACT

In various examples, a memory may comprise a first subarray having an associated first staging buffer, a second subarray having an associated second staging buffer, and request logic. The request logic may: receive a first write request associated with the first subarray, receive a second write request associated with the second subarray, store the first write request in the first staging buffer, store the second write request in the second staging buffer, and execute the first write request and the second write request.

### BACKGROUND

Computing devices may be coupled to a memory. The memory may execute read and write operations.

### BRIEF DESCRIPTION OF THE DRAWINGS

Certain examples are described in the following detailed description and in reference to the drawings, in which:

FIG. 1 is a conceptual diagram of an example computing device that may perform staging of write requests;

FIG. 2 is another conceptual diagram of an example computing device of an example computing system that may perform staging of write requests;

FIG. 3 is another conceptual diagram of an example computing device of an example computing system that may perform staging of write requests;

FIG. 4 is another conceptual diagram of an example computing device of an example computing system that may perform staging of write requests;

FIG. 5 is a flowchart of an example method for performing perform staging of write requests;

FIG. 6 is a flowchart of an example method perform staging of write requests;

FIG. 7 is a flowchart of an example method perform staging of write requests;

FIG. 8 is a flowchart of an example method perform staging of write requests;

### DETAILED DESCRIPTION

A computing device may comprise a processor, such as a central processing unit (CPU). The CPU may be coupled with a media controller, which may generate reads and writes to at least one memory coupled to the controller. In some examples, the memory may comprise multiple subarrays or banks. Each subarray may comprise a unit of the memory that can be independently accessed (i.e. written or read).

The techniques of this disclosure are directed to staging writes to the memory. More particularly, this disclosure describes a media controller that stages writes for a memory. This disclosure also describes a memory that comprises a plurality of staging buffers. One staging buffer is associated with each subarray of the memory. The media controller issues writes to the memory, and the memory stores the write requests in the staging write buffer associated with the subarray of each write request. Writes stored in a staging buffer are said to be “staged.” When the memory receives a write request associated with a subarray that has a write pending (i.e. has a write stored in its associated staging buffer), the memory may issue all the staged writes such that the staged writes execute in parallel. The memory stores the new write in its associated staging buffer.

By storing writes in staging buffers, the memory can use a single write sequence controller to execute each of the writes in parallel. Using a single write sequence controller for each of the subarrays on the memory die may reduce the complexity of the memory die while also reducing the latency of performing multiple writes by allowing the memory die to perform the writes in parallel rather than in series.

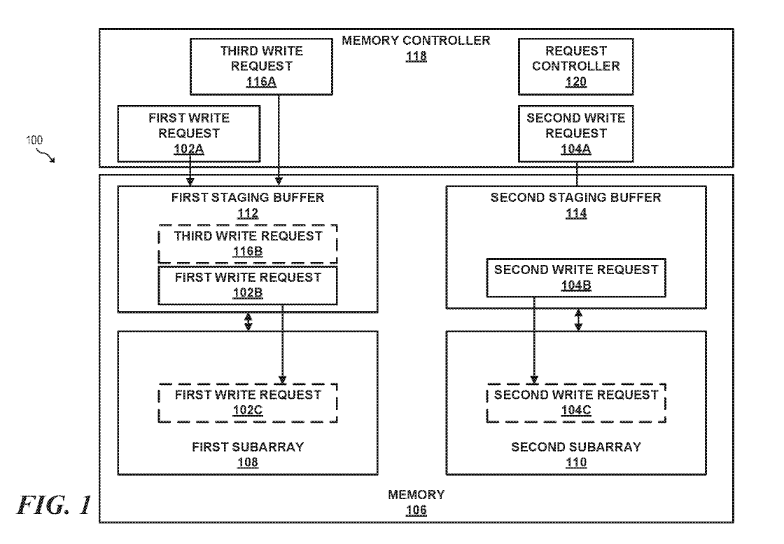

FIG. 1 is a conceptual diagram of an example computing device that may perform staging of write requests. Computing system 100 is illustrated in FIG. 1. Computing system 100 comprises a memory 106, a memory controller 118, a first write request 102A-1020, and a second write request 104A-1040, and a third write request 118A-B.

In various examples, memory 106 may comprise one or more of dynamic memory, such as double data rate (DDR) random access memory (RAM), static RAM, graphics DDR RAM, (GDDR), high bandwidth memory (HBM), or Hybrid Memory Cube or the like. In some examples, memory 106 may comprise non-volatile memory such as: NAND flash memory, resistive ram (ReRam), phase change RAM (PCRAM), spin transfer torque memory (STTRAM), magneto resistive RAM, or the like. In various examples, memory 106 may comprise a die. The die may be mounted on a dynamic inline memory module, printed circuit board (PCB), a PCIe (Peripheral Component Interconnect Express) card, or the like. Memory 106 comprises a first subarray 108 and a second subarray 110. Although only two subarrays are illustrated in FIG. 1, any number of subarrays may be present in memory 106.

Each subarray, i.e. first subarray 108 and a second subarray 110 may comprise multiple different addressable memory locations. Each subarray, e.g. first subarray 108 and a second subarray 110, is an independently accessible unit within memory 106. Different addresses of first subarray 108 and a second subarray 110 may be accessed in parallel. For example, processor 106 may execute a read operation at a first address of first subarray 108, and write data to a second, different address of second subarray 110 in parallel.

System 100 also comprises memory controller 118. In some examples, memory controller 118 may comprise a media controller that is external to memory 106. In various examples, memory controller 118 may comprise at least a part of a memory controller, which may be coupled to at least one central processing unit (CPU). In some examples, memory controller 118 may comprise a media controller that is on a printed circuit board along with memory 106. In yet some other examples, memory controller 118 may be distributed and may comprise a plurality of discrete and/or integrated devices.

Memory controller 118 comprises request controller 120. Request controller 120 may comprise one or more of: a field programmable gate array (FPGA), fixed function logic, an application-specific integrated circuit (ASIC), a digital signal processor (DSP), or a CPU. Request controller 120 receives read and write requests, e.g. from a CPU or a memory controller. Memory controller 118 and the memory controller may be coupled via memory interface, a PCIe interface, a fabric, or the like. In the example of FIG. 1, request controller 120 may generate first write request 102A, and second write request 104A in response to receiving write requests.

Based on each received read or write request, request controller 120 generates a corresponding read or write request that is associated with a particular subarray of memory 106. In some examples, request controller 120 may 118 determine the subarray associated with each generated read or write request based on a physical address from each read or write request.

Responsive to generating a read or write request, request controller 120 stores the read or write request in a staging buffer of memory 106, e.g. first staging buffer 112 or second staging buffer 114. Memory 106 stores writes in the staging buffers until Memory 106 receives a write signal from memory controller 118.

In the example of FIG. 1, request controller 120 generates first write request 102A, which is associated with first subarray 108. Request controller 120 then stores first write request 102A in first staging buffer 112. Responsive to receiving a second write request, request controller 120 generates second write request 104A. Second write request 104A is associated with second staging buffer 114. Request controller 120 stores second write request 104A in second staging buffer 114. For ease of illustration, first write request 102A and second write request 104A are referred to as first write request 102B and second write request 104B once they are stored in first staging buffer 112 and second staging buffer 114.

For the purposes of illustration, first write request 102A and second write request 104A are illustrated as being associated with first subarray 108 and second subarray 110. It should be noted that any number of subarrays may be present within memory 106, and that first write request 102A and second write request 104A may be assigned to any of those subarrays. Memory 106 may receive first write request 102A and second write request 104A in any order.

In the example of FIG. 1, memory controller 118 receives a third write request, which is associated with first subarray 108. Responsive to receiving the third write request, request controller 120 generates third write request 116A, which is associated with first subarray 108. However, first write request 102B already occupies first staging buffer 112, which is associated with first subarray 108, and cannot store another write request in first staging buffer 112. In the event that request controller 120 issues a write request to a subarray having an occupied staging buffer, request controller 120 issues a write operation to memory 106. Although third write request 116A is illustrated as being associated with first subarray 108, third write request 116A may be assigned to any subarray having an occupied staging buffer.

The write operation causes memory 106 to execute all staged writes, e.g. first write request 102B and second write request 104B. For ease of understanding first write request 102B is referred to as first write request 102C during execution of the write operation, and first write request 102C is illustrated as being inside first subarray 108, the subarray with which first write request 102 is associated. Similarly, second write request 104B is referred to as second write request 104C during execution, and is also illustrated inside second subarray 110, the subarray with which second write request 1040 is associated.

In addition to issuing a write request to cause memory 106 to execute first write request 102C and second write request 104C, request controller 120 may store third write request 116A in first staging buffer 112. Third write request 116B is referred to as third write request 116B once stored in first staging buffer 112.

In some examples, request controller 120 may issue a stage buffer flush command to memory 106. The stage buffer flush causes memory 106 to execute all staged write commands, e.g. first write request 102B and second write request 104B.

In the example of FIG. 1, processor 118 generates first write request 102 and second write request 104. First write request 102 is associated with first subarray 108, and therefore first staging buffer 112. Second write request 104 is associated with second subarray 110, and therefore second staging buffer 114. Processor 118 may assign first write request 102 and second write request 104 to first subarray 108 and second subarray 110 based on the addresses specified in each request, as an example.

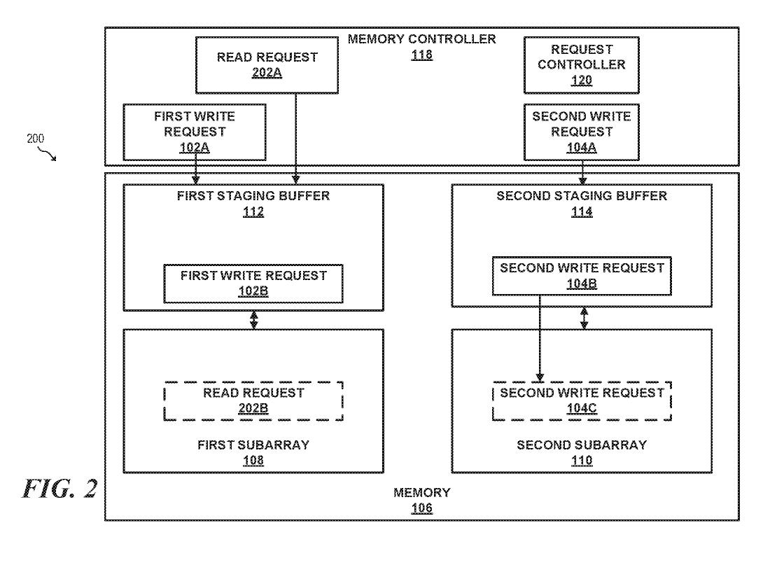

FIG. 2 is another conceptual diagram of an example computing device that may perform staging of write requests. FIG. 2 illustrates a computing system 200. In various examples, computing system 200 may be similar to computing system 100 (FIG. 1). In addition to memory 106, processor 118, and medium 120, which are illustrated in FIG. 1, computing system 200 comprises read request 202A-202B.

In the example of FIG. 2, request controller 120 receives a read request for a particular address. Request controller 120 determines that the read request is associated with first subarray 108, and generates read request 202A. After issuing first write request 102A and second write request 104B, which are stored in first staging buffer 112 and second staging buffer 114, Request controller 120 receives the read request and generates request 202A.

In some cases, the latency associated with executing a read operation at an address of memory 106 may be lower than the executing a write request. In various examples, there may be a benefit to gathering multiple writes to execute in parallel. In these examples, request controller 120 may issue the read request, i.e. read request 202A, and cause memory 106 to execute the read request before performing a staged write request. As an example, request controller 120 may issue read request 202A after issuing first write request 102A. Memory 106 may execute read request 202A, which is referred to during execution as read request 202. To indicate execution, read request 202B is illustrated inside first subarray 108.

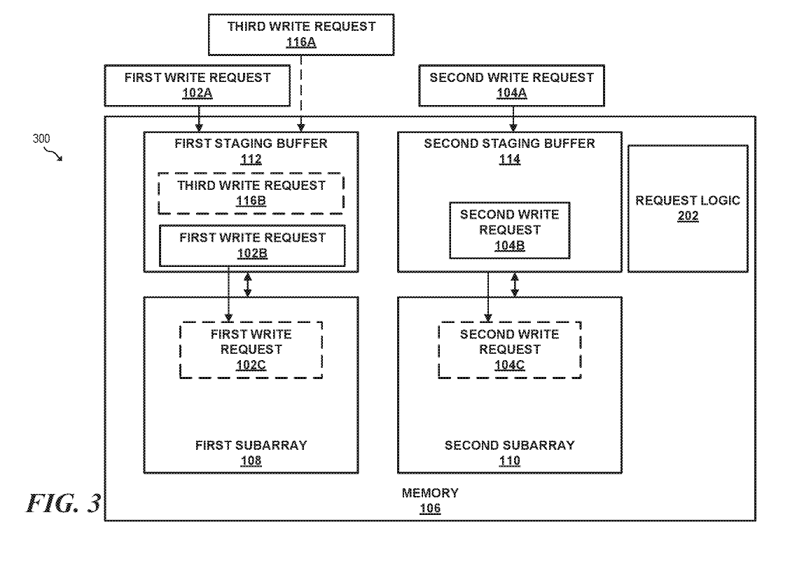

FIG. 3 is another conceptual diagram of an example computing device that may perform staging of write requests. FIG. 3 illustrates a computing system 300. Computing system 300 comprises a memory 106, which is similar to memory 106 of FIGS. 1 and 2. Memory 106 receives first write request 102A and second write request 104A.

Request logic 202 of memory 106 may process and/or execute read or write requests issued to memory 106. Another device, such as a memory controller (e.g. memory controller 118 of FIG. 1), a memory controller, or the like may issue the read and write requests to memory 106. Request logic 202 may comprise at least one of fixed logic or programmable logic in various examples.

Responsive to receiving first write request 102A and second write request 104A, request logic 202 causes memory 106 to store first write request 102A and second write request 104A in first staging buffer 112 and second staging buffer 114, respectively. First write request 102A and second write request 104A are referred to as first write request 102B and second write request 104B once they are stored in first staging buffer 112 and second staging buffer 114.

After request logic 202 receives stages first write request 102A and second write request 104A, i.e. stores first write request 102B and second write request 104B in first staging buffer 112 and second staging buffer 114, memory 106 may receive a third write request 116A. Request logic 202 determines that third write request 116A is associated with first subarray 108.

Due to first staging buffer 112 being occupied by first write request 102B, request logic 202 may cause memory 106 to execute a write operation. Executing the write operation causes memory 106 to write the contents of first write request 1020 and second write request 1040 to first subarray 108, and second subarray 110, respectively. During write execution, first write request 102 and second write request 104 are referred to as first write request 1020 and second write request 1040. Additionally, first write request 1020 and second write request 1040 are illustrated inside first subarray 108 and a second subarray 110 during write execution. In some examples, responsive to, or in parallel with executing the write operation, request logic 202 may store third write request 116B in first staging buffer 112.

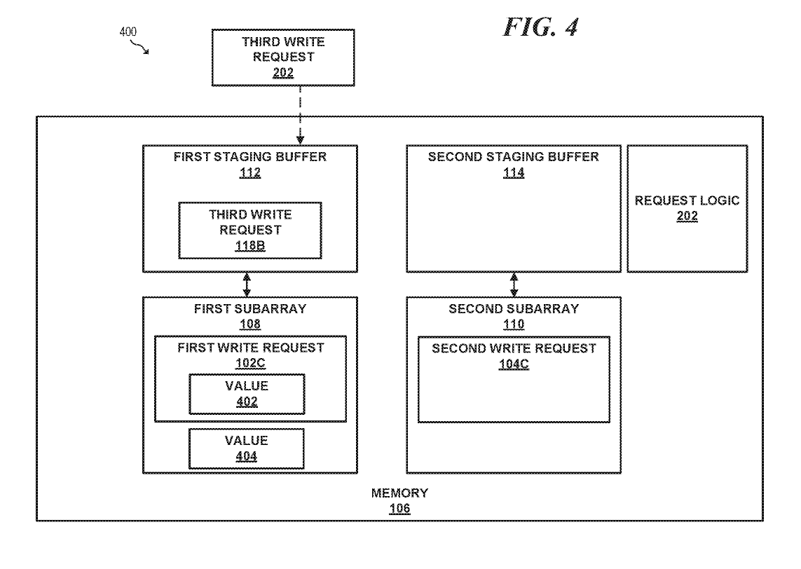

FIG. 4 is another conceptual diagram of an example computing device that may perform staging of write requests. FIG. 4 illustrates a computing system 400. Computing system 400 comprises memory 106, which may be similar to memory 106 of FIGS. 1, 2, and 3 in various examples. In the example of FIG. 4, request logic 202 is executing first write request 102C and second write request 1040.

In various examples illustrated in FIG. 4, to execute first write request 102C and second write request 1040, request logic 202 compares the value stored at the address to be written with the value to be written to the address and determines the difference (e.g. bitwise difference) between the values. Request logic 202 may then write the difference value rather than the entire value to avoid wearing out the memory cells at that address. Thus, when writing third write request 118C, request logic 202 compares values 402 and 404 to determine a bitwise difference value to an address within first subarray 108. Request logic 202 attempts to write the difference value to the address of first subarray 108 associated with first write request 102C.

After writing the value to the address, request logic 202 may read the value stored at the address to verify that the contents have been successfully written to the address and that a write failure did not occur. If a write failure occurred, request logic 202 may re-attempt the write operation, e.g. first write request 102C or second write request 104C.

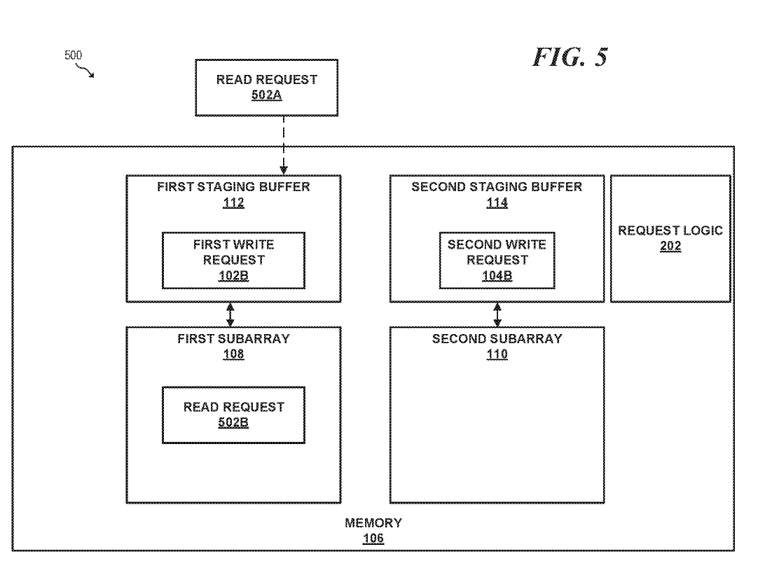

FIG. 5 is another conceptual diagram of an example computing device that may perform staging of write requests. FIG. 5 illustrates a computing system 500. Computing system 500 comprises memory 106, which may be similar to memory 106 of FIGS. 1, 2, 3, and 4 in various examples. In the example of FIG. 5, request logic 202 has staged first write request 102B and second write request 104B.

Sometime after receiving and staging first write request 102B and second write request 104B, memory 106 may receive a read request, e.g. read request 502A. Memory 106 may receive read request 502A from a media controller or a memory controller, as examples. Request logic 202 determines that read request 502A is associated with first subarray 108, which has a staged write, i.e. first write request 102B.

Request logic 202 may be instructed to, or may issue the read request, i.e. read request 202A. Thus, request logic 202 may execute the read request, e.g. read request 502B, before performing a staged write request, e.g. first write request 102B. To indicate execution, read request 502B is illustrated inside first subarray 108.

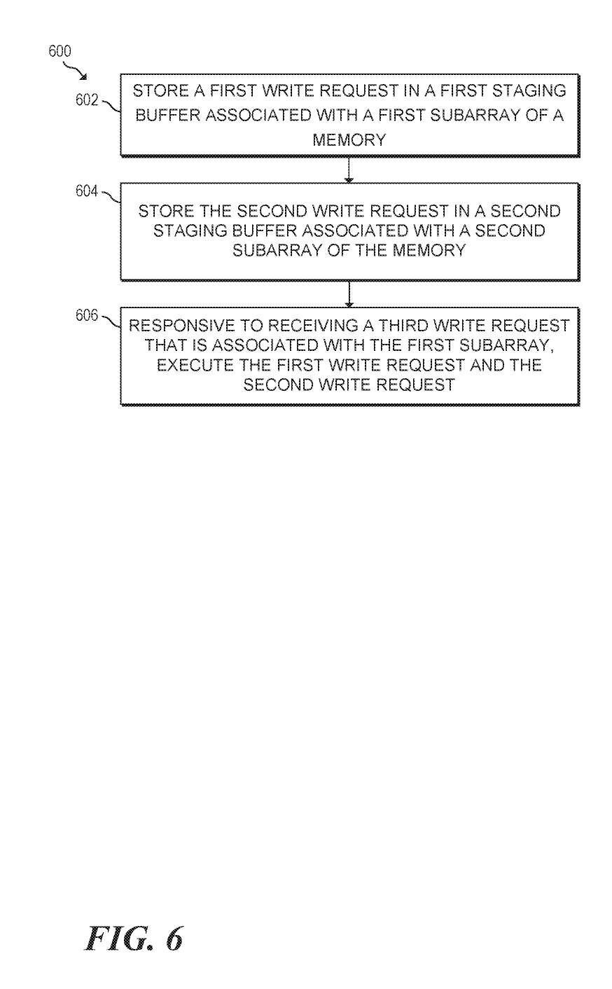

FIG. 6 is a flowchart of an example method for performing staging of write requests. FIG. 6 illustrates method 600. Method 600 may be described below as being executed or performed by a system, for example, computing system 100 (FIG. 1), computing system 200 (FIG. 2), computing system 300 (FIG. 3), computing system 400 (FIG. 4), or computing system 500 (FIG. 5).

In various examples, method 600 may be performed by hardware, software, firmware, or any combination thereof. Other suitable systems and/or computing devices may be used as well. Method 600 may be implemented in the form of executable instructions stored on at least one machine-readable storage medium of the system and executed by at least one processor of the system. Alternatively or in addition, method 600 may be implemented in the form of electronic circuitry (e.g., hardware). In alternate examples of the present disclosure, one or more blocks of method 600 may be executed substantially concurrently or in a different order than shown in FIG. 6. In alternate examples of the present disclosure, method 600 may include more or fewer blocks than are shown in FIG. 6. In some examples, one or more of the blocks of method 600 may, at certain times, be ongoing and/or may repeat.

Method 600 may start at block 602 at which point memory controller 118 and/or memory 106 may store a first write request (e.g. first write request 102A) in a first staging buffer (e.g. first staging buffer 112). The first staging buffer may be associated with a first subarray (e.g. first subarray 108) of the memory.

At block 604, memory controller 118 and/or memory 106 may store a second write request (e.g. second write request 104A) in a second staging buffer (e.g. second staging buffer 114). The second staging buffer is associated with a second subarray of the memory.

At block 606, responsive to memory 106 receiving a third write request that is associated with the first subarray (e.g. third write request 116A), memory controller 118 may cause and/or memory 106 may execute the first write request and the second write request.

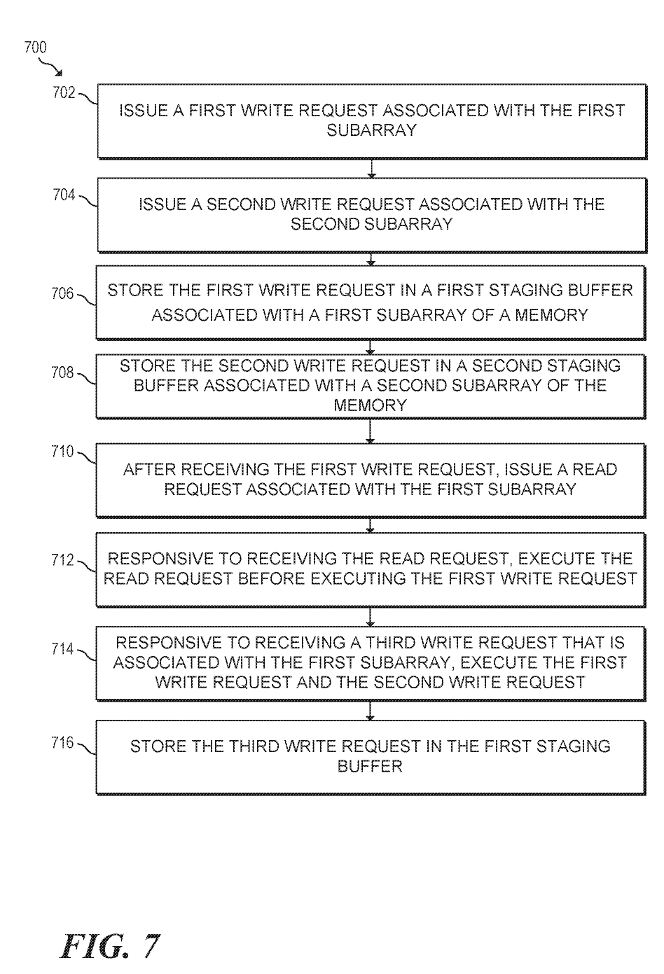

FIG. 7 is a flowchart of an example method for performing staging of write requests. FIG. 7 illustrates method 700. Method 700 may be described below as being executed or performed by a system, for example, computing system 100 (FIG. 1), computing system 200 (FIG. 2), computing system 300 (FIG. 3), computing system 400 (FIG. 4), or computing system 500 (FIG. 5). Other suitable systems and/or computing devices may be used as well. Method 700 may be implemented in the form of executable instructions stored on at least one machine-readable storage medium of the system and executed by at least one processor of the system. Method 700 may be performed by hardware, software, firmware, or any combination thereof.

Alternatively or in addition, method 700 may be implemented in the form of electronic circuitry (e.g., hardware). In alternate examples of the present disclosure, one or more blocks of method 700 may be executed substantially concurrently or in a different order than shown in FIG. 7. In alternate examples of the present disclosure, method 700 may include more or fewer blocks than are shown in FIG. 7. In some examples, one or more of the blocks of method 700 may, at certain times, be ongoing and/or may repeat.

In various examples, method 700 may start at block 702 at which point memory controller 118 may issue a first write request (e.g. first write request 102A). The first write request is associated with a first subarray (e.g. first subarray 108). At block 704, memory controller 118 may issue a second write request (e.g. second write request 104A). The second write request is associated with a second subarray (e.g. second staging buffer 114) of the memory.

At block 706, memory controller 118 and/or memory 106 may store the first write request in a first staging buffer (e.g. first staging buffer 112). The first staging buffer is associated with the first subarray of the memory. At block 708, memory controller 118 and/or memory 106 may store a second write request in a second staging buffer. The second staging buffer is associated with the second subarray of the memory.

At block 710, after receiving the first write request, memory controller 118 may issue request, issuing a read request (e.g. read request 502A or 202A). The read request is associated with the first subarray. At block 712, responsive to receiving the read request, memory 106 may execute the read request before executing the first write request.

At block 714, responsive to memory 106 receiving a third write request that is associated with the first subarray (e.g. third write request 116A), memory controller 118 may cause and/or memory 106 may execute the first write request and the second write request. At block 716, memory controller 118 and/or memory 106 may store the third write request in the first staging buffer.

In some examples, to execute the first write request, memory controller 118 and/or memory 106 may read a value of an address in the first subarray that is associated with the first write request. Memory controller 118 and/or memory 106 may determine a difference between a value to be written to the first address (e.g. value 302), and a stored value of the address (e.g. value 304). Memory 106 may write the difference between the values to the address, and verify that the value to be written was successfully stored to the address.

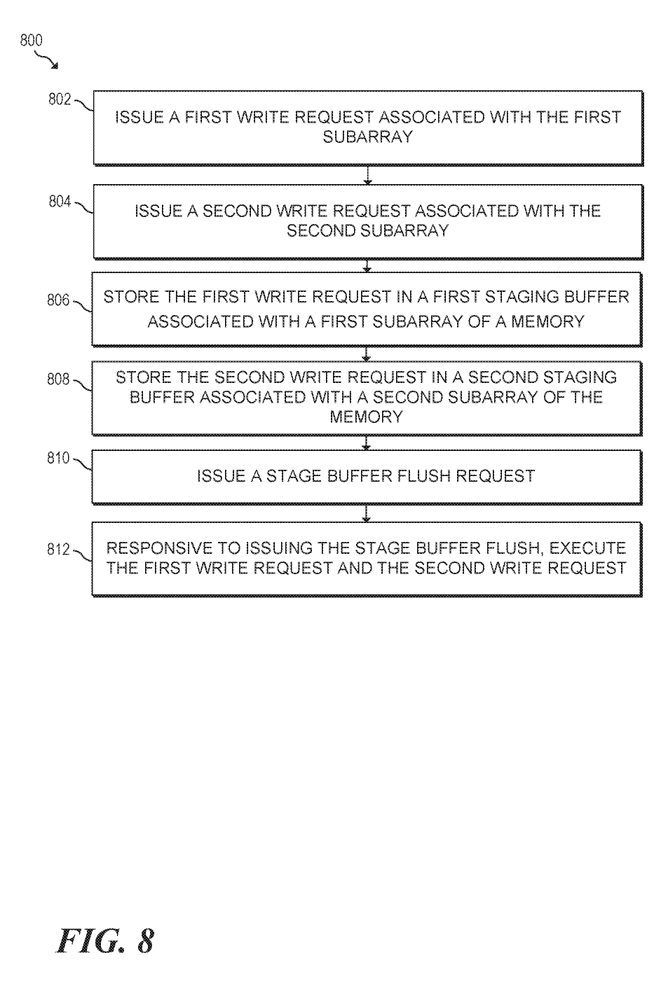

FIG. 8 is a flowchart of an example method for performing staging of write requests. FIG. 8 illustrates method 800. Method 800 may be described below as being executed or performed by a system, for example, computing system 100 (FIG. 1), computing system 200 (FIG. 2), computing system 300 (FIG. 3), computing system 400 (FIG. 4), or computing system 500 (FIG. 5). Other suitable systems and/or computing devices may be used as well. Method 800 may be implemented in the form of executable instructions stored on at least one machine-readable storage medium of the system and executed by at least one processor of the system. Method 800 may be performed by hardware, software, firmware, or any combination thereof.

Alternatively or in addition, method 800 may be implemented in the form of electronic circuitry (e.g., hardware). In alternate examples of the present disclosure, one or more blocks of method 800 may be executed substantially concurrently or in a different order than shown in FIG. 8. In alternate examples of the present disclosure, method 800 may include more or fewer blocks than are shown in FIG. 8. In some examples, one or more of the blocks of method 800 may, at certain times, be ongoing and/or may repeat.

In various examples, method 800 may start at block 802 at which point memory controller 118 may issue method 700 may start at block 802 at which point memory controller 118 may issue a first write request (e.g. first write request 102A). The first write request is associated with a first subarray (e.g. first subarray 108). At block 804, memory controller 118 may issue a second write request (e.g. second write request 104A). The second write request is associated with a second subarray (e.g. second staging buffer 114) of the memory.

At block 806, memory controller 118 and/or memory 106 may store the first write request in a first staging buffer (e.g. first staging buffer 112). The first staging buffer is associated with the first subarray of the memory. At block 808, memory controller 118 and/or memory 106 may store a second write request in a second staging buffer. The second staging buffer is associated with the second subarray of the memory.

At block 810, after receiving the first write request, memory controller 118 may issue a stage buffer flush. At block 812, responsive to issuing the stage buffer flush, memory 106 may execute the first write request and the second write request. In some examples, memory controller 118 may cause memory 106 to execute the first write request and the second write request using a same write control sequence. The same write control sequence may comprise one or more of: a same write pulse strength, write pulse duration, or the like.

1. A method comprising:
storing a first write request in a first staging buffer, wherein the first staging buffer is associated with a first subarray of a memory;
storing a second write request in a second staging buffer, wherein the second staging buffer is associated with a second subarray of the memory; and
responsive to receiving a third write request that is associated with the first subarray, executing the first write request and the second write request.

2. The method of claim 1, comprising:
issuing the first write request, wherein the first write request is associated with the first subarray; and
issuing the second write request, wherein the second write request is associated with the second subarray of the memory.

3. The method of claim 1, comprising:
after receiving the first write request, issuing a read request, wherein the read request is associated with the first subarray; and
responsive to receiving the read request, executing the read request before executing the first write request.

4. The method of claim 1, wherein executing the first write request comprises:
reading a value of an address in the first subarray that is associated with the first write request;
determining a difference between a value to be written to the first address and a stored value of the address;
writing the difference between the values to the address; and
verifying that the value to be written was successfully stored to the address.

5. The method of claim 1, comprising:
issuing a stage buffer flush request;
and responsive to issuing the stage buffer flush request, executing the first write request and the second write request.

6. The method of claim 1, comprising:
storing the third write request in the first staging buffer.

7. The method of claim 1, wherein the first write request and the second write request are executed using a same write control sequence.

8. A device comprising a memory comprising:
a first subarray having an associated first staging buffer;
a second subarray having an associated second staging buffer; and
request logic to:
receive a first write request associated with the first subarray;
receive a second write request associated with the second subarray;
store the first write request in the first staging buffer;
store the second write request in the second staging buffer; and
execute the first write request and the second write request.

9. The device of claim 8, the request logic to:
after receiving the first write request, receive a read request wherein the read request is associated with the first subarray; and
responsive to receiving the read request, execute the read request before executing the first write request.

10. The device of claim 8, wherein to execute the first write request, the request logic to:
read a value of an address in the first subarray that is associated with the first write request;
determine a difference between a value to being written to the first address and a stored value of the address;
write the difference between the values to the address; and
verify that the value to being written was successfully stored to the address.

11. The device of claim 8, wherein the request logic to:
determine that executing the first write request has failed; and
responsive to determining that the first write request has failed, re-attempt the first write request.

12. The device of claim 8, the request logic to:
receive a third write request, wherein the third write request is associated with the first subarray,
wherein the processor to execute the first write request and the second write request responsive to receiving the third write request.

13. The device of claim 8, the request logic to:
store the third write request in the first staging buffer.

14. A device comprising a memory controller, comprising:
a request controller to:
issue, to a memory coupled to the controller, a first write request associated with a first subarray of the memory, wherein issuing the first write causes the first write to be stored in a first staging buffer associated with a first subarray of the memory,
issue a second write request associated with a second subarray of the memory, wherein issuing the second write causes the second write to be stored in a second staging buffer associated with a second subarray; and
issue a third write request associated with the first subarray, wherein issuing the third request causes the memory to execute the first write request and the second write request.

15. The device of claim 14, wherein to issue the third write request, the request controller to:
store the third write request in the first staging buffer.

16. The device of claim 14, the request controller to:
issue a stage buffer flush that causes the memory to execute the first write request and the second write request.

17. The device of claim 14, the request controller to:
determine that the first write has not executed; and
issue a write request associated with the first subarray that causes the memory to execute the read request before executing the first write request.
